(19) United States
(12) Patent Application Publication
(10) Pub. No.: US 2024/0208566 A1
(43) Pub. Date: Jun. 27, 2024

(54) VEHICLE STEERING DEVICE

(71) Applicant: HL MANDO CORPORATION, Pyeontaek (KR)

(72) Inventor: Kyungsub SHIN, Suwon (KR)

(21) Appl. No.: 18/478,990

(22) Filed: Sep. 30, 2023

(30) Foreign Application Priority Data
Dec. 23, 2022 (KR) 10-2022-0182600

(51) Int. Cl. B62D 5/04

(52) U.S. Cl. CPC B62D 5/0472

(57) ABSTRACT

The present embodiments provide a vehicle steering device comprising an actuator rod linearly reciprocating in an axial direction, a holder assembly having a first holder and a second holder separated by being axially cut and disposed with their respective cut surfaces facing each other and coupled to the actuator rod to linearly reciprocate in the axial direction, a rod housing having the actuator rod embedded therein and having an inner surface where two opposite surfaces of the holder assembly are supported, and an elastic member coupled between the cut surfaces of the first holder and the second holder to support the first holder and the second holder toward the rod housing.

### CROSS-REFERENCE TO RELATED APPLICATION

This application claims priority from Korean Patent Application No. 10-2022-0182600, filed on Dec. 23, 2022, which is hereby incorporated by reference in its entirety for all purposes.

### BACKGROUND

### Field

The present embodiments relate to a vehicle steering device and, more specifically, to a vehicle steering device that is designed to enhance the measurement accuracy of the steering angle and minimize noise and vibration while maintaining high durability even following exposure to impact and vibration from the road conditions.

### Description of Related Art

In general, the vehicle steering device plays a role to steer vehicle wheels according to the driving conditions of the vehicle with, e.g., a hydraulic device or motor and a reducer and typically works on the rear wheels in regular vehicles or on the front wheels in the steer-by-wire system.

In the vehicle steering device, the axial movement of the sliding shaft is measured by a sensor for sensing the movement of a magnet, and the sensor measures the displacement of an object linearly reciprocating and, based thereupon, the electronic control unit (ECU) stably controls rotation of the vehicle.

However, the conventional vehicle steering device may not precisely measure changes in the axial displacement of the sliding shaft due to, e.g., the mounting structure of the magnet and sensor and the surrounding components, deteriorating the measurement accuracy of the steering angle.

Further, after impact and vibration are delivered from the road while driving the vehicle, noise and vibration increase, and the measurement accuracy of the steering angle is sharply reduced. Thus, there is ongoing research for enhancing durability.

### BRIEF SUMMARY

Conceived in the foregoing background, the present embodiments provides a vehicle steering device that may increase the measurement accuracy of the steering angle by precisely measuring a change in the axial displacement of the sliding shaft and minimize noise and vibration while maintaining the measurement accuracy of the steering angle even after impact and noise are delivered from the road.

In an aspect, the present embodiments may provide a vehicle steering device comprising an actuator rod linearly reciprocating in an axial direction, a holder assembly having a first holder and a second holder separated by being axially cut and disposed with their respective cut surfaces facing each other and coupled to the actuator rod to linearly reciprocate in the axial direction, a rod housing having the actuator rod embedded therein and having an inner surface where two opposite surfaces of the holder assembly are supported, and an elastic member coupled between the cut surfaces of the first holder and the second holder to support the first holder and the second holder toward the rod housing.

The present embodiments may provide a vehicle steering device comprising an actuator rod linearly reciprocating in an axial direction, a holder assembly coupled to the actuator rod to, together with the actuator rod, linearly reciprocate in the axial direction, a rod housing having the actuator rod embedded therein and having an inner surface where two opposite surfaces of the holder assembly are supported, and an elastic supporting member coupled to two opposite outer surfaces of the holder assembly and supported on an inner surface of the rod housing.

According to the present embodiments, it is possible to provide a vehicle steering device that may increase the measurement accuracy of the steering angle by precisely measuring a change in the axial displacement of the sliding shaft and minimize noise and vibration while maintaining the measurement accuracy of the steering angle even after impact and noise are delivered from the road.

### DESCRIPTION OF DRAWINGS

The above and other objects, features, and advantages of the disclosure will be more clearly understood from the following detailed description, taken in conjunction with the accompanying drawings, in which:

FIG. 1 is a perspective view illustrating a vehicle steering device according to the present embodiments;

FIG. 2 is an exploded perspective view of FIG. 1;

FIGS. 3 and 4 are perspective views illustrating a vehicle steering device according to the present embodiments;

FIG. 5 is an exploded perspective view illustrating a vehicle steering device according to the present embodiments;

FIGS. 6 and 7 are cross-sectional views illustrating a vehicle steering device according to the present embodiments;

FIG. 8 is an exploded perspective view illustrating a vehicle steering device according to the present embodiments; and

FIG. 9 is a cross-sectional view illustrating a vehicle steering device according to the present embodiments.

### DETAILED DESCRIPTION

In the following description of examples or embodiments of the disclosure, reference will be made to the accompanying drawings. In the drawings, it is shown by way of illustration specific examples or embodiments that can be implemented. In the drawings, the same reference numerals and signs can be used to designate the same or like components even when they are shown in different accompanying drawings from one another. Further, in the following description of examples or embodiments of the disclosure, detailed descriptions of well-known functions and components incorporated herein may be omitted when they may obscure the subject matter in some embodiments of the disclosure. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

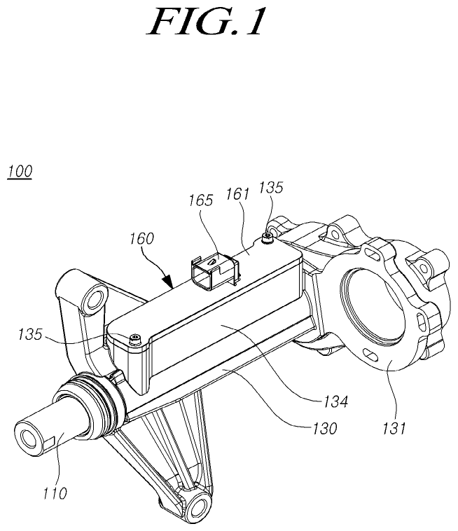

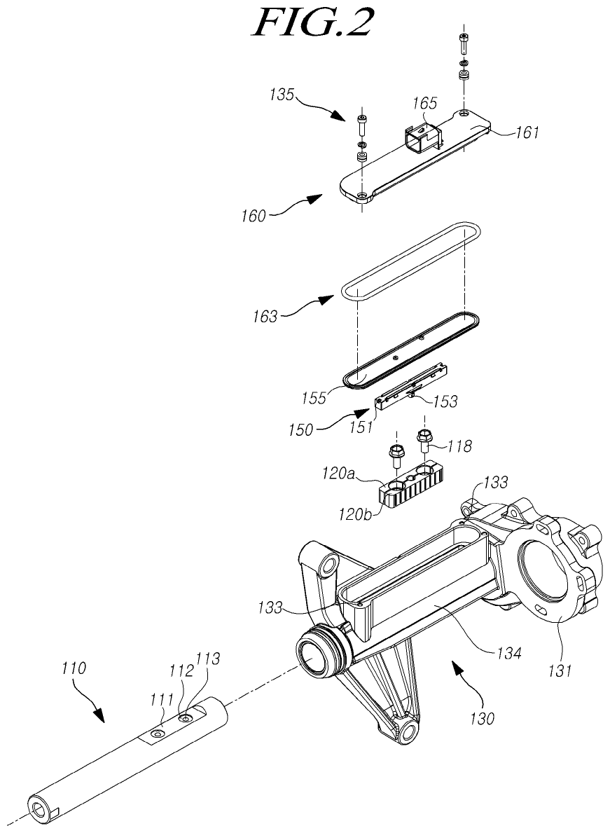

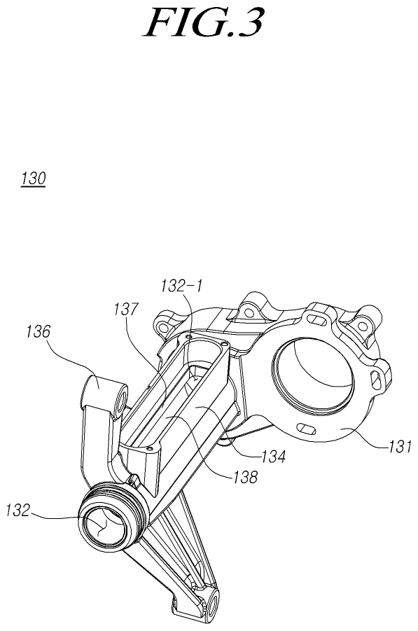

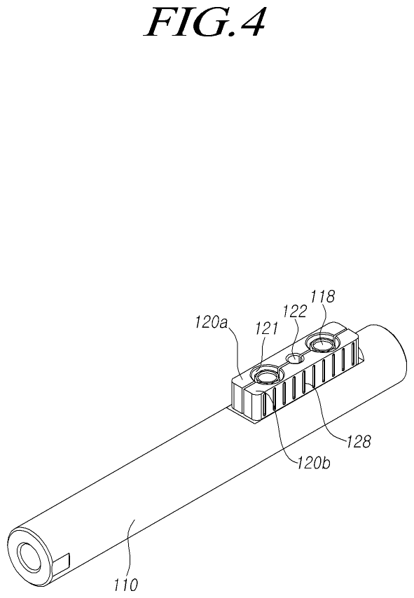

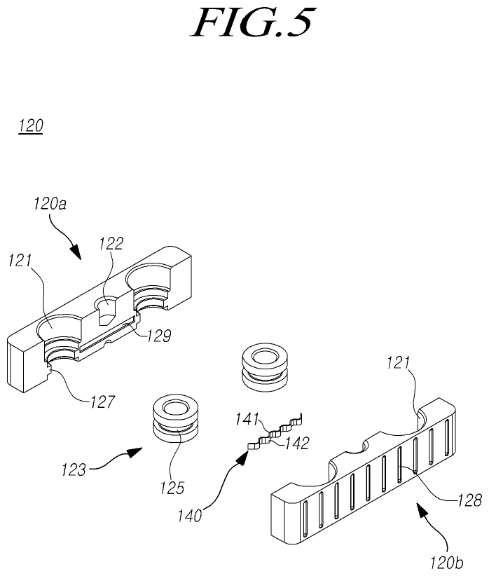

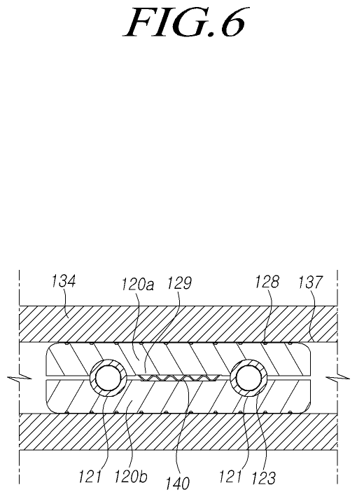

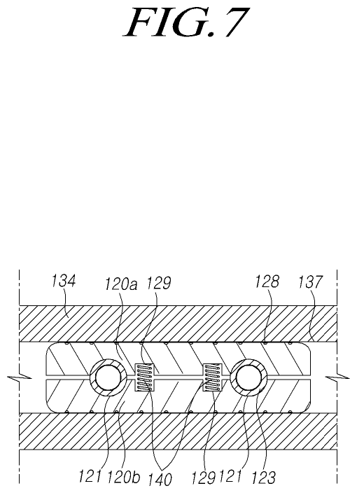

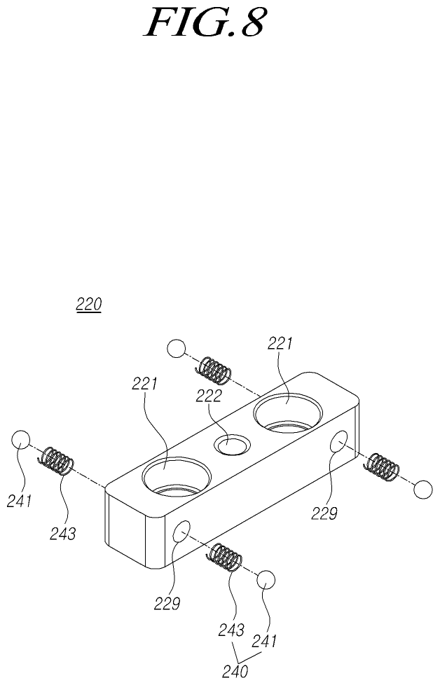

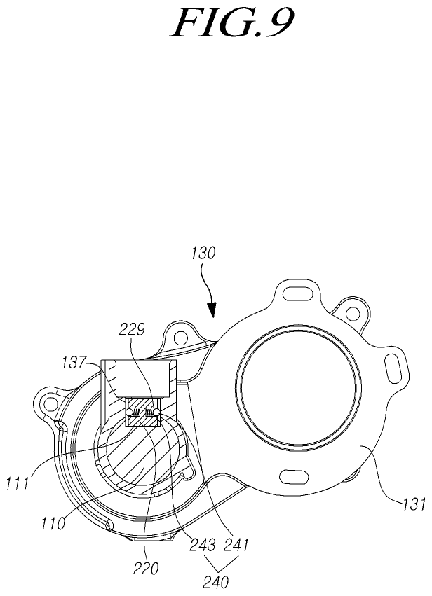

FIG. 1 is a perspective view illustrating a vehicle steering device according to the present embodiments. FIG. 2 is an exploded perspective view of FIG. 1. FIGS. 3 and 4 are perspective views illustrating a vehicle steering device according to the present embodiments. FIG. 5 is an exploded perspective view illustrating a vehicle steering device according to the present embodiments. FIGS. 6 and 7 are cross-sectional views illustrating a vehicle steering device according to the present embodiments. FIG. 8 is an exploded perspective view illustrating a vehicle steering device according to the present embodiments. FIG. 9 is a cross-sectional view illustrating a vehicle steering device according to the present embodiments.

As shown in FIGS. 1 to 7, a vehicle steering device 100 according to an embodiment of the present disclosure includes an actuator rod 110, a holder assembly 120, a rod housing 130, and an elastic member 140. The actuator rod 110 is generally in a cylindrical shape and linearly reciprocates in the rod housing 130 in an axial direction. The holder assembly 120 has a first holder 120a and a second holder 120b separated by being axially cut and disposed with their respective cut surfaces facing each other and coupled to the actuator rod 110 to linearly reciprocate in the axial direction, together with the actuator rod 110. The rod housing 130 has the actuator rod 110 embedded therein and has an inner surface where two opposite surfaces of the holder assembly 120 are supported. The elastic member 140 is coupled between the cut surfaces of the first holder 120a and the second holder 120b to support the first holder 120a and the second holder 120b toward the rod housing 130.

Further, the vehicle steering device according to the present embodiments may further include a magnet assembly 150 having a magnet 151 embedded therein and coupled to the holder assembly 120 to, together with the actuator rod 110, linearly reciprocate in the axial direction.

Further, the vehicle steering device according to the present embodiments may further include a sensor assembly 160 coupled to the rod housing 130 to sense a change in a magnetic field of the magnet 151 when the actuator rod 110, together with the magnet 151, linearly reciprocates.

The vehicle steering device 100 according to the present embodiments performs vehicle steering while the actuator rod 110 linearly reciprocates in the axial direction. This process involves sensing a change in the magnetic field of the magnet 151 which is positioned in the magnet assembly 150 and moves linearly along with the actuator rod 110. The sensor assembly 160 functions to detect such change in the magnetic field. Subsequently, the changes in axial displacement of the rod 110 is transmitted to the electronic control unit (not shown), enabling the calculation of the steering angle.

The actuator rod is embedded in the rod housing 130 and linearly reciprocates in the axial direction. The holder assembly 120 is coupled to the actuator rod and axially slides together with the actuator rod 110 inside the rod housing 130.

The actuator rod 110 is capable of axial movement through a belt (not shown) that is screwed with a ball nut (not shown) to deliver the driving force of a motor (not shown), and the electronic control unit may calculate the steering angle through a change in the magnetic field of the magnet 151 sensed by the sensor assembly 160 to control the driving of the motor.

The motor and belt, and the ball nut are embedded in a driver fastening portion 131 formed on one side of the rod housing 130, and a detailed description of the embedded components is omitted.

The actuator rod 110 has a seating surface 111 that is formed by cutting a portion of the outer circumferential surface of the actuator rod 110 into a flat plane. The holder assembly 120 is seated on the seating surface 111 of the actuator rod 110 and is coupled with the actuator rod 110 via the fastening member 118.

The holder assembly 120 has a first holder 120a and a second holder 120b axially cut and separated. The first holder 120a and the second holder 120b may be descried as being divided and separated along the axial direction and a radial direction of the actuator rod 110 when assembled. The first holder 120a and the second holder 120b may be formed to be symmetrical to each other and disposed facing each other in a circumferential direction of the actuator rod 110. The first holder 120a and the second holder 120b may be coupled to the actuator rod 110 to linearly reciprocate in the axial direction together with the actuator rod 110.

Fastening holes 113 are formed axially spaced apart to each other in the seating surface 111 of the actuator rod 110. The holder assembly 120 has communication recesses 121 which communicate with the fastening holes 113 and are formed in the cut surfaces of the first holder 120a and the second holder 120b facing each other, so that the fastening member 118 is coupled to the fastening holes 113 and the communication recesses 121.

The surfaces of the first holder 120a and the second holder 120b which face each other are referred to as the cut surfaces. The communication recesses in the first holder 120a and the second holder 120b may be formed in a semicircle and may be formed recessed in a circumferential direction from the cut surfaces, such that when the first holder 120a and the second holder 120b are assembled, a pair of one communication recess on the first holder 120a and one communication recess on the second holder 120b may form a circle at a position corresponding to one of the fastening holes 113.

Further, a ring-shaped member 123 may be coupled to the communication recesses 121 of the holder assembly 120 and may be penetrated by the fastening member 118 when assembled. However, without limitations thereto, the ring-shaped member 123 may be integrally molded and formed with the holder assembly 120. For example, the ring-shaped member 123 may be integrally molded and formed with one of the first holder 120a or the second holder 120b. The ring-shaped member 123 may have a same height with the first/second holder 120a, 120b in the radial direction of the actuator rod 110.

Here, the ring-shaped member 123 has a stopping groove 125 recessed to be stepped from the outer circumferential surface. The stopping groove 125 is formed in a circular manner along the outer circumferential surface of the ring-shaped member 123. The communication recess 121 may have a protrusion 127 protruding from the circumferential surface of the communication recess 121. The communication recess 121 is formed in a half-circular manner along the circumferential surface of the communication recess 121 of each of the first/second holder 120a, 120b. A protrusion 127 may be inserted into the stopping recess 125 of the ring-shaped member 123 when assembled.

A seating supporting recess 112 may be formed recessed from the seating surface 111. The seating supporting recess 112 is formed to surround the fastening hole 113 of the seating surface 111. The seating supporting recess 112 has a shape and a size such that an end portion of the ring-shaped member 123 may be inserted into and supported by the seating supporting recess 112 when the holder assembly 120 and the actuator rod 110 are coupled. The seating supporting recess 112 has a shape and a size such that the end of the ring-shaped member 123 is precisely fixed in the seating supporting recess 112.

According to an embodiment, the magnet assembly 150 is supported and coupled to the holder assembly 120. A magnet 151 is embedded in the magnet assembly 150. The sensor assembly 160 senses the variation in the axial displacement of the actuator rod based on the change in the magnetic field when the actuator rod 110 linearly moves in the axial direction together with the magnet assembly 150.

The magnet assembly 150 is formed with an insertion supporting portion 153 protruding downward from the center of a bottom surface of the magnet assembly 150. The downward direction of the magnet assembly 150 is a same direction with a radially inward direction of the actuator rod 110 when the magnet assembly 150 is assembled with the holder assembly 120 and the actuator rod 110.

The holder assembly 120 has an insertion supporting recess 122 in the top center portion thereof. A half of the insertion supporting recess 122 is formed at the center of an edge between a top surface and the cut surface of the first holder 120a. The top surface of the first holder 120a refers to radial outer surface of the first holder 120 based on the actuator rod 110. The other half of the insertion supporting recess 122 is formed at the center of an edge between a top surface and the cut surface of the second holder 120b.

The insertion supporting portion 153 and the insertion supporting recess 122 may be formed with shapes and sizes such that the insertion supporting portion 153 of the magnet assembly 150 is inserted into and precisely fixed in the insertion supporting recess 122 so that the magnet assembly 150, together with the holder assembly 120, moves in the axial direction.

Further, according to an embodiment, an elastic supporting grooves 129 may be provided in the cut surface of each of the first holder 120a and the second holder 120b. An elastic supporting grooves 129 may be formed in each of the cut surfaces of the first/second holder 120a, 120b such that they are corresponding each other as a pair and they form, when assembled, a space in which an elastic member 140 is inserted and by which the elastic member 140 is supported.

The elastic supporting groove 129 may be formed as an axially elongated recess. The elastic supporting groove may be formed between communication recesses 121 formed on a cut surface of the first/second holder 121a, 121b.

The elastic member 140 has a first convex portion 141 protruding toward the first holder 120a and a second convex portion 142 protruding toward the second holder 120b such that the elastic member 140 elastically support and are coupled to the elastic supporting grooves 129 of the first holder 120a and the second holder 120b.

The elastic member 140 may have a plurality of first convex portions 141 and a plurality of second convex portions 142 alternately and continuously disposed in the axial direction. The elastic member 140, by being disposed between the first/second holders 120a, 120b, may support, and apply an elastic force to, the first/second holders 120a, 120b toward directions away from each other. Thereby, when the holder assembly 120 is assembled with the actuator rod 110, the first/second holders 120a, 120b are supported towards the supporting surface 137 (to be described later).

As shown in FIG. 7, according to an embodiment, two or more elastic supporting grooves 124 may be provided in each of the cut surfaces of the first/second holders 120a, 120b, such that they form pairs of elastic supporting grooves. Each pair includes one elastic supporting groove 124 in the first holder 120a and one elastic supporting groove 124 in the second holder 120b and forms a space in which the elastic member 140 is inserted. The elastic member 140 may be a coil spring having two opposite ends respectively supported in the elastic supporting grooves 129 of the first holder 120a and the second holder 120b. Thereby, the elastic member, when assembled, applies an elastic force to the first/second holders 120a, 120b towards directions away from each other.

Further, a holder groove 128 may be provided by being recessed inward in the outer circumferential surface of each of the first holder 120a and the second holder 120b. The outer circumferential surface of the first/second holder 120a/120b is the surfaces opposite to the cut surfaces of the first/second holder 120a/120b.

The holder groove 128 is formed to be elongated vertically. A plurality of holder grooves 128 axially spaced apart may be formed. The vertical direction may be the radial direction of the actuator rod 110 when the holder assembly 120 is assembled with the actuator rod 110.

The holder groove 128 may be filled with a lubricant, minimizing friction with the inner surface of the rod housing 130 when the holder assembly 120 axially moves. The inner surface may be referred to as the supporting surface 137 of the mounting portion 134 of the rod housing 130.

The housing cover 161 is provided at an upper side of the sensor assembly 160 and is coupled to the fixing hole 133 formed in an upper end of the mounting portion 134 of the rod housing 130 through a fixing member 135. The housing cover 161 protects inner electric components of the sensor assembly 160.

The mounting portion 134 is formed on the rod housing 130 by protruding in a box shape having an inner space. An inner surface of the mounting portion 134 surrounding the inner space may be referred to as the supporting surface 137 where the holder assembly 120 is supported. The magnet assembly 150 and the sensor assembly 160 are inserted into the inner space surrounded by the supporting surface 137. The magnet assembly 150 and the sensor assembly 160 may be disposed relatively at an upper side in the inner space when assembled. The holder assembly 120 may be disposed relatively at a lower side in the inner space when assembled.

A mounting bracket 136 is provided on one side of the rod housing 130 to be fixed to the vehicle body.

The rod housing 130 has a cylinder space 138 therein. The above-described actuator rod 110 is inserted in the cylinder space 138. The cylinder space is formed at a lower side of the supporting surface 137. Through holes 132, 132-1 are provided at two opposite ends of the cylinder space 138 to allow the actuator rod 110 to pass therethrough for a linear movement.

A seal member 163 may be coupled between the housing cover 161 and the mounting portion 134 of the rod housing 130 to prevent influx of a foreign substance from outside. A guide member 155 is provided under the housing cover 161 for supporting and guiding axial movement of the magnet assembly 150.

The sensor assembly 160 includes, e.g., a sensor and a circuit board and is fixed to the upper end of the mounting portion 134 of the rod housing 130. A binding terminal 165 is provided on an upper side of the sensor assembly 160 for electrically connecting to the electronic control unit of the vehicle. The binding terminal 165 may be coupled with a wire connector.

Referring to FIGS. 8 and 9 together with FIGS. 1 to 7, a vehicle steering device according to an embodiment of the present disclosure may include an actuator rod 110, a holder assembly 220, a rod housing 130, and an elastic supporting member 240. The embodiments descried with reference to FIGS. 8 and 9 are similar with the embodiments described with reference to FIGS. 1 to 7 except for the configuration related to the holder assembly 220 and the elastic supporting member 240. Therefore, other detailed description may be omitted.

The actuator rod 110 linearly reciprocates in an axial direction. The holder assembly 220 is coupled to the actuator rod 110 to linearly reciprocate in the axial direction together with the actuator rod 110. The rod housing 130 has the actuator rod 110 embedded therein and has an inner surface where two opposite surfaces of the holder assembly 220 are supported. The elastic supporting member 240 is coupled to two opposite outer surfaces of the holder assembly 220 and supported on an inner surface of the rod housing 130.

Here, since the actuator rod 110 and the rod housing 130 are the same as those described above in connection with FIGS. 1 to 7, a detailed description thereof is omitted.

As shown in FIG. 8, the holder assembly 220 is formed as a single body. The holder assembly 220 has communication holes 221 which are spaced apart from each other in the axial direction of the actuator rod 110 and communicate with the fastening holes 113 of the actuator rod 110.

A supporting hole 222 is formed in the central portion of the upper surface of the holder assembly 220 by being recessed downward from the upper surface. The insertion supporting portion 153 of the magnet assembly 150 is inserted into and supported by the supporting hole 222.

Coupling recesses 229 are provided in two opposite outer surfaces of the holder assembly 220. The coupling recesses 229 are formed on the two opposite outer surfaces of the holder assembly 220 by being recessed inward therefrom. The direction in which the coupling recesses 229 are recessed from the outer surfaces may be a circumferential direction of the actuator rod 110 when the holder assembly 220 is assembled with the actuator rod 110. The elastic supporting members 240 are coupled to the coupling recesses 229 and disposed between the holder assembly 220 and the supporting surface 137 of the rod housing.

The elastic supporting member 240 includes a supporting end member 241 supported on an inner surface (i.e., the supporting surface 137) of the rod housing 130 and an inserted elastic member 243. The inserted elastic member 243 has a first end inserted into the coupling recess 229 and a second end elastically supporting the supporting end member 241 toward and to the supporting surface 137 inside the rod housing 130.

Here, the supporting end member 241 is formed in a spherical shape to roll in point contact while the holder assembly 220 moves, minimizing friction with the rod housing 130.

Further, as the supporting end member 241 is supported on the supporting surface 137, the holder assembly 220 and the supporting surface 137 may remain spaced apart, minimizing vibration, friction, and noise when the holder assembly 220 reciprocates.

According to the embodiments of the present disclosure having the above-described structure and shape, it is possible to provide a vehicle steering device that may enhance the measurement accuracy of the steering angle by precisely measuring a change in the axial displacement of the sliding shaft. The embodiments also may minimize noise and vibration while maintaining the measurement accuracy of the steering angle even in the presence of road impact and noise delivered from the road.

The above description has been presented to enable any person skilled in the art to make and use the technical idea of the disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the disclosure. The above description and the accompanying drawings provide an example of the technical idea of the disclosure for illustrative purposes only. That is, the disclosed embodiments are intended to illustrate the scope of the technical idea of the disclosure. Thus, the scope of the disclosure is not limited to the embodiments shown, but is to be accorded the widest scope consistent with the claims. The scope of protection of the disclosure should be construed based on the following claims, and all technical ideas within the scope of equivalents thereof should be construed as being included within the scope of the disclosure. Also, it is noted that any one feature of an embodiment of the present disclosure described in the specification may be applied to another embodiment of the present disclosure.

What is claimed:

1. A vehicle steering device, comprising:
an actuator rod linearly reciprocating in an axial direction;
a holder assembly having a first holder and a second holder separated by being axially cut and disposed with their respective cut surfaces facing each other and coupled to the actuator rod to linearly reciprocate in the axial direction;
a rod housing having the actuator rod embedded therein and having an inner surface where two opposite surfaces of the holder assembly are supported; and
an elastic member coupled between the cut surfaces of the first holder and the second holder to support the first holder and the second holder toward the rod housing.

2. The vehicle steering device of claim 1, further comprising a magnet assembly having a magnet embedded therein and coupled to the holder assembly to, together with the actuator rod, linearly reciprocate in the axial direction.

3. The vehicle steering device of claim 2, further comprising a sensor assembly coupled to the rod housing to sense a change in a magnetic field of the magnet when the actuator rod linearly reciprocates.

4. The vehicle steering device of claim 1, wherein the actuator rod has a seating surface where an outer circumferential surface is cut, and wherein the holder assembly is seated on the seating surface and is coupled via a fastening member.

5. The vehicle steering device of claim 4, wherein fastening holes are provided being axially spaced apart from each other in the seating surface to couple the fastening member.

6. The vehicle steering device of claim 5, wherein the holder assembly has communication recesses formed in the cut surfaces of the first holder and the second holder to communicate with the fastening hole.

7. The vehicle steering device of claim 6, wherein a ring-shaped member is provided by being penetrated by the fastening member and being coupled to the communication recesses of the first holder and the second holder.

8. The vehicle steering device of claim 7, wherein the ring-shaped member has a stopping groove recessed to be stepped from an outer circumferential surface, wherein a protrusion is provided on an inner circumferential surface of the communication recess, and wherein the protrusion is inserted into the stopping groove.

9. The vehicle steering device of claim 1, wherein the cut surfaces of the first holder and the second holder have an elastic supporting groove where the elastic member is inserted and supported.

10. The vehicle steering device of claim 9, wherein the elastic supporting groove is formed as an axially elongated recess, and wherein the elastic member includes a first convex portion protruding toward the first holder and a second convex portion protruding toward the second holder.

11. The vehicle steering device of claim 10, wherein the elastic member includes a plurality of first convex portions and a plurality of second convex portions continuously and alternately connected in the axial direction.

12. The vehicle steering device of claim 9, wherein two or more elastic supporting grooves axially spaced apart are provided.

13. The vehicle steering device of claim 12, wherein the elastic member is a coil spring having two opposite ends respectively supported on the elastic supporting groove of the first holder and the elastic supporting groove of the second holder.

14. The vehicle steering device of claim 1, wherein a holder groove recessed inward is provided in an outer surface of each of the first holder and the second holder.

15. The vehicle steering device of claim 14, wherein a plurality of holder grooves are provided being axially spaced apart.

16. The vehicle steering device of claim 15, wherein the holder groove is filled with a lubricant.

17. A vehicle steering device, comprising:
an actuator rod linearly reciprocating in an axial direction;
a holder assembly coupled to the actuator rod to, together with the actuator rod, linearly reciprocate in the axial direction;
a rod housing having the actuator rod embedded therein and having an inner surface where two opposite surfaces of the holder assembly are supported; and
an elastic supporting member coupled to two opposite outer surfaces of the holder assembly and supported on an inner surface of the rod housing.

18. The vehicle steering device of claim 17, wherein a coupling recess where the elastic supporting member is coupled is provided in the two opposite outer surfaces of the holder assembly.

19. The vehicle steering device of claim 18, wherein the elastic supporting member includes:
a supporting end member supported on an inner surface of the rod housing; and
an inserted elastic member having a first end inserted to the coupling recess and a second end elastically supporting the supporting end member to the inner surface of the rod housing.

20. The vehicle steering device of claim 19, wherein the supporting end member is formed in a spherical shape.
